(19) United States
(12) Patent Application Publication
(10) Pub. No.: US 2025/0102226 A1
(43) Pub. Date: Mar. 27, 2025

(54) FRAME SYSTEM FOR DRYING A CONTAINER

(71) Applicant: Illinois Tool Works Inc., Glenview, IL (US)

(72) Inventor: Timothy Douglas Hessel, Cincinnati, OH (US)

(21) Appl. No.: 18/887,083

(22) Filed: Sep. 17, 2024

Related U.S. Application Data
(60) Provisional application No. 63/584,937, filed on Sep. 25, 2023.

(51) Int. Cl. F26B 25/00; F26B 15/12; F26B 21/00

(52) U.S. Cl. CPC F26B 25/003; F26B 15/128; F26B 21/004

(57) ABSTRACT

A system for drying a container includes an air manifold having a plurality of outlets to deliver pressurized air toward passing containers. A surface, such as a conveyer belt, supports one or more such containers. A frame including a track or rollers is arranged at a predetermined distance from the surface, the frame being configured to brace the one or more containers against forces acting on the one or more containers from the pressurized air.

### CROSS REFERENCE TO RELATED APPLICATIONS

This application is a Non-Provisional Patent Application claiming priority to U.S. Provisional Patent Application No. 63/584,937 entitled “Frame System For Drying A Container” filed Sep. 25, 2023, which is herein incorporated by reference in its entirety.

### BACKGROUND

The present disclosure relates generally to fluid discharge devices and, more particularly, to a frame system for drying containers.

A variety of systems transfer fluids from a fluid supply source to one or more fluid discharge devices. In some systems, an arrangement of fluid conduits, which may include metal pipes, plastic pipes, and/or hoses, may provide a flow path for routing, channeling, or otherwise delivering a fluid from a fluid supply source to a fluid discharge device, such as an air manifold. In the case of an air manifold, air received via an inlet may be pressurized and directed through a series of nozzles. The output of the nozzles may be used for a variety of applications, such as drying and removing moisture from objects, removing dust or debris, cooling, surface preparation, and so forth. As may be appreciated, the directed air may be delivered with a force sufficient to blow a container from the system. Thus, techniques to deliver adequate air without blowing away the containers is desirable.

Further limitations and disadvantages of conventional and traditional approaches will become apparent to one of skill in the art, through comparison of such systems with the present disclosure as set forth in the remainder of the present application with reference to the drawings.

### BRIEF SUMMARY

Further limitations and disadvantages of conventional and traditional approaches will become apparent to one of skill in the art, through comparison of such systems with the present disclosure as set forth in the remainder of the present application with reference to the drawings.

A system is provided for drying a container. The system includes an air manifold having a plurality of outlets to deliver pressurized air toward passing containers. A surface, such as a conveyer belt, supports one or more such containers. A frame including a track or rollers is arranged at a predetermined distance from the surface, the frame being configured to brace the one or more containers against forces acting on the one or more containers from the pressurized air.

These and various other advantages, aspects and novel features of the present disclosure, as well as details of an illustrated embodiment thereof, will be more fully understood from the following description and drawings.

### BRIEF DESCRIPTION OF THE DRAWINGS

Certain aspects of embodiments disclosed herein by way of example are summarized below. It should be understood that these aspects are presented merely to provide the reader with a brief summary of certain forms an invention disclosed and/or claimed herein might take, and that these aspects are not intended to limit the scope of any invention disclosed and/or claimed herein. Indeed, any invention disclosed and/or claimed herein may encompass a variety of aspects that may not be set forth below.

FIG. 1 is a perspective view of an example system for drying a container, in accordance with aspects of this disclosure.

FIG. 2 is an end view of the examples system for drying a container, in accordance with aspects of this disclosure.

FIG. 3 is a top view of the examples system for drying a container, in accordance with aspects of this disclosure.

The figures are not necessarily to scale. Where appropriate, similar or identical reference numbers are used to refer to similar or identical components.

### DETAILED DESCRIPTION

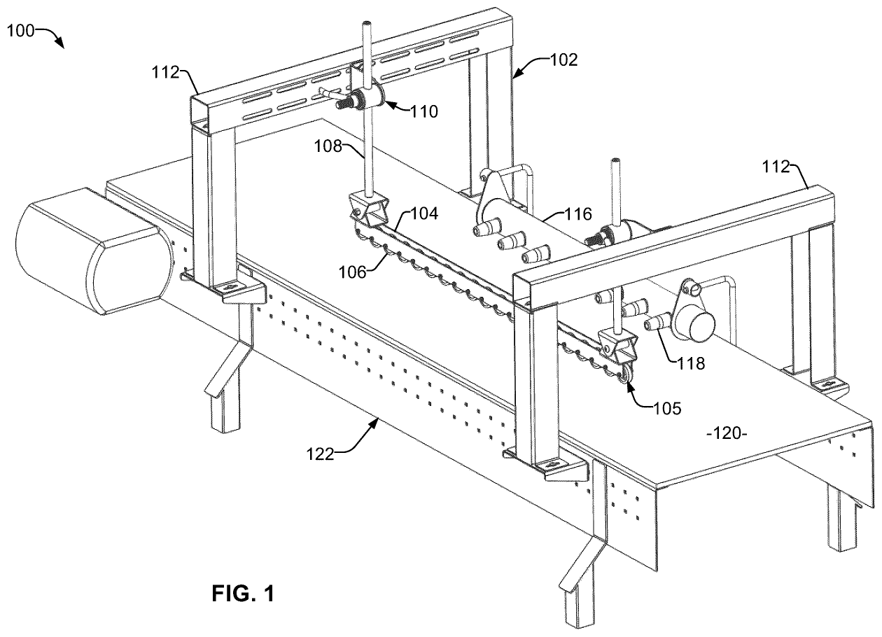

Turning now to the drawings, FIG. 1 illustrates a processing system 100 that may incorporate one or more aspects of the presently disclosed techniques. The system 100 includes components to deliver air to remove water off pouches or other containers (e.g., sides, tops, necks, gussets, crevices, etc.), to dry the container prior to packaging, for example. The system 100 includes an air manifold 116 having a plurality of outlets or nozzles 118 to deliver pressurized air (e.g., from an air compressor). The outlets 118 are mounted to and/or oriented from a platform 122 toward a portion of a surface 120, which is configured to support one or more containers (e.g., a pouch, a bottle, a bag, a box, etc.). Although in some examples the containers are illustrated with one or more representative shapes, the disclosed system is applicable to any variety of containers. Further, the containers may be formed with a rigid, flexible, and/or semi-flexible enclosure. In some examples, the containers are designed to be filled with a variety of products (e.g., particulates, food items, gels, and/or liquids, such as beverages and intravenous fluids, etc.).

A frame 102 is mounted to the platform 122, with one or more support braces 112 configured to bolster the frame relative to the platform 122 and/or the surface 120. One or more mounting devices 108 are employed to maintain one or more components of the frame 102 at a distance relative to the surface 120. For instance, a frame or support 105 can be arranged such that a distance or gap exists between the surface 120 and a portion of the frame 105. The frame 105 can include one or more rails or supports 104 to receive a component to make contact with the container, such as rollers 106, a track, a bumper, or other suitable device.

In some examples, the mounting devices 108 include one or more adjustable fasteners 110 configured to adjust the distance or gap between the rollers 106 and the surface 120. The mounting devices 108 can include a post, bar, chain, or other suitable device, which can raise or lower the position of the frame 105. In some examples employing multiple mounting devices, each corresponding fastener could be adjusted such that each mounting device extends equally from a corresponding fastener, while in other examples one or more mounting devices extends from a corresponding fastener by a different amount, resulting in some rollers being closer to the surface than other rollers. The adjustable fastener may be manually adjustable, may require a tool, may be adjusted by a motor controlled by a user interface or computer program, and/or may be fixed during manufacture by welding, bonding, gluing, and/or other similar process.

Although some examples illustrate a single frame 105 arranged along the surface 120 (e.g., between opposing frames 112), in other examples two or more frames may be used. For instance, one frame may include rollers 106, while another frame may be a track. However, two or more frames with rollers or tracks may be employed.

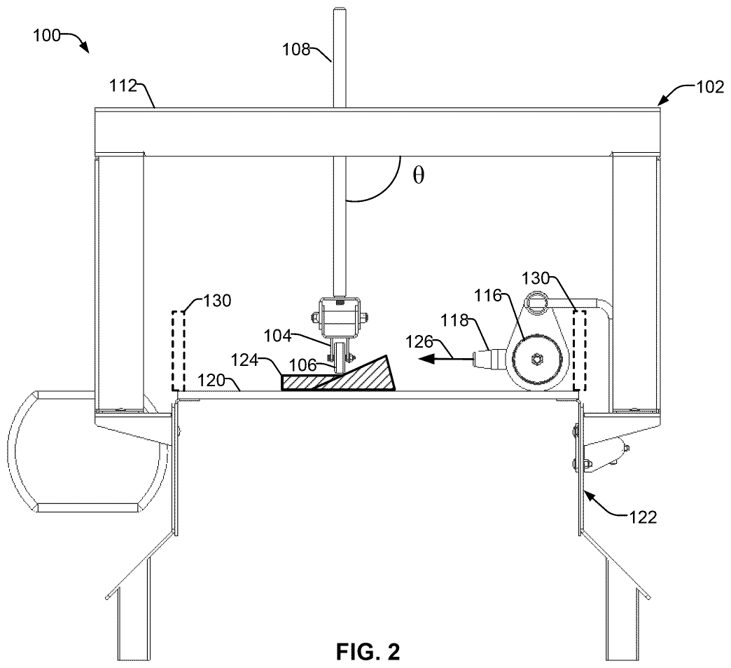

In some examples, a single frame can include both rollers and tracks, either inline and/or in parallel. The rollers and tracks may be arranged adjacent to one another, such that each makes contact with the container at a common or proximate portion of the container. In other examples, the rollers and tracks may be separated by a gap, such that each makes contact with the container at a different portion of the container. For instance, the rollers may be aligned to allow the containers to pass underneath (as shown in detail in FIG. 2), while the track may be arranged with a smaller gap relative to the surface 120 to block any loose containers from being blown from the system 100.

Once assembled, the rollers 106 (or track) brace containers 124 against forces acting on the one or more containers from pressurized air 126 dispensed from the outlets 118, as shown in the illustration of FIG. 2. As shown, the rollers 106 are arranged at an angle θ relative to a direction of flow of the pressurized air 126, such that as the containers 124 are forced away from the outlets 118, a portion of the container makes contact with the rollers 106, preventing the containers from being blown from the surface 120.

In some examples, the rollers 106 are oriented at a different, making contact with the container 124 at a different location and/or different angle thank a vertically oriented roller. The angle of the rollers 106 may be adjusted relative to the container 124, the surface 120, the outlets 118 and/or the direction of the air flow 126. The angle of the rollers 106 can be adjusted by movement of the position or orientation of the mounting devices 108 and/or rails 104 supporting the rollers 106. Such adjustments may accommodate different sizes, shapes, weights, and/or composition of the container and/or filler.

In some examples, the rails 104 may run along opposing sides of the rollers 106, allowing the rollers to rotate in response to movement of the containers 124. This rotating motion allows for continued movement of containers 124 across the surface 120 while being dried by the pressurized air 126. In some examples, the rollers 106 may have a rubber coating to create a softer contact with the container and/or provide a grip with the passing container.

The rollers 106 can rotate freely, such that the rollers are configured to rotate when contact and movement of the containers provide sufficient force to cause rotation of the rollers. In some examples, the rollers can be driven by a motor or other actuator, such that advancement of the containers is assisted by the driven rollers.

Containers 124 may have a variety of shapes or sizes, and may be made of a variety of materials. For instance, the containers may be somewhat or substantially cylindrical, flat, rectangular, round, triangular, elliptical, or other suitable shape. A substantial portion of the container may fit between the rollers 106 and the surface 120, or only a small subset of the container may fit in the gap therebetween. The containers may be made of a material that is somewhat or substantially flexible, such that contact with the rollers causes some amount of deformation of the container. In other examples, the containers may have a substantially rigid exterior, such that contact with rollers has a limited effect on the shape or size of the passing container.

As shown, container 124 has a larger base oriented facing the outlets 118, thus to receive the pressurized air 126. The force from the pressurized air 126 may dry the container 124 (e.g., by blowing air to move liquid or moisture). The pressurized air may also force the containers to a desired location along the surface 120 (e.g., to align with packaging), and/or to expand a gusseted portion of the pouch's base.

In some examples, the position of the rollers is fixed relative to the surface (e.g., the position of the mounting devices 108 is fixed within the adjustable fasteners 110, and/or the position of the rollers 106 is fixed within the rails 104). Thus, the gap between the rollers and the surface is substantially unchanged during a drying operation.

In other examples, the position of the rollers relative to the surface can change in response to a contact force. For instance, the mounting devices 108 may be movable yet biased away from the fasteners 110 (e.g., by a spring), and/or the rollers 106 may be movable yet biased away from the rails 104. Thus, the gap between the rollers and the surface can change in response to contact forces from passing containers. This flexibility may be particularly useful for drying operations for substantially rigid containers.

In some examples, borders, walls or fencing 130 may be arranged along the sides of the platform 122 and/or the surface 120 to prevent loose containers 124 from being blown from the system 100 during a drying operation.

Although in some examples the angle θ is substantially perpendicular to the surface 120, the relative angle may be adjusted to accommodate a variety of applications, including for containers of a different size, shape, and/or material, speed of conveyance, force applied from the pressurized air, as a list of non-limiting examples. Similarly, although in some examples the rollers 106 are arranged at a distance from the surface 120 such that the central axis of the rollers are approximately aligned with an output of the outlets, the distance can be increased or decreased based on difference in a particular system or container to be dried.

In some examples, a position and/or orientation of the air manifold 116 and/or one or more outlets 118 may be adjusted relative to the surface 120 and/or the rollers 106. Such an adjustment may accommodate different sizes, shapes, weights, and/or composition of the container and/or filler. In some examples, a first outlet is oriented in a direction different from a second outlet within the manifold and/or between manifolds along the direction of conveyance 128.

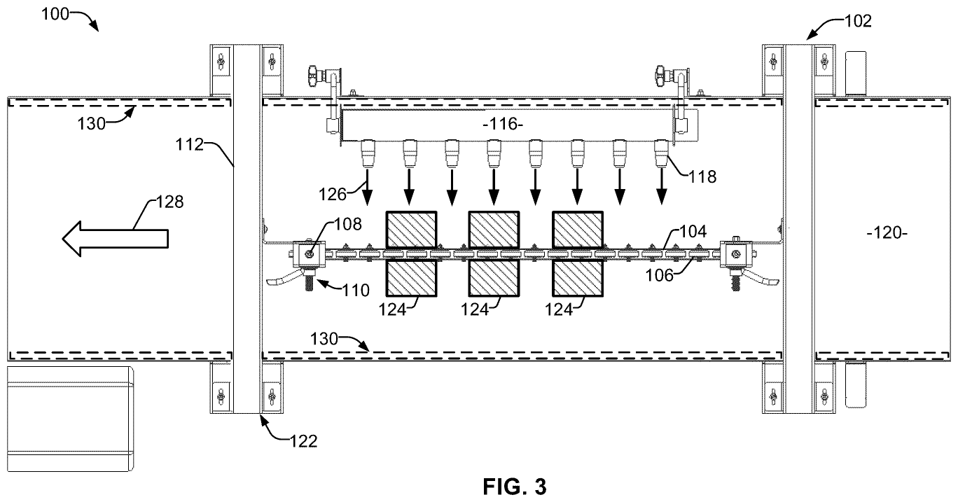

FIG. 3 provides a top plan view of the system 100. In the illustrated example, the surface 120 is part of a conveyer system employing a movable belt to convey the containers 124 along the conveyer system. Thus, surface 120 can be a surface of a conveyer belt being driven by a motor integrated with or connected to the platform 122 (e.g., mounted below the surface). The rails 104 and rollers 106 are arranged inline with the direction of conveyance 128, such that the rollers rotate with the containers as they traverse the system 100.

The belt moves the containers 124 in the direction 128, such that pressurized air 126 is applied to each container 124 as it passes the outlets 118. Although in some examples the outlets 118 are illustrated as being equally spaced apart and oriented in a common direction (e.g., angle and orientation relative to the manifold 116 and/or frame 105), in other examples one or more outlets are angled and/or oriented differently from at least one other outlet.

Thus, a predetermined distance or gap can be selected based on the size and/or shape of the containers to allow the containers to traverse the frame while contacting one or more surfaces of the containers during application of the pressurized air.

Although some examples are provided where the outlets deliver pressurized air, in other examples other fluids (e.g., gases, liquids) are delivered to the passing containers. In some examples, a pressurized fluid is introduced to the manifold 116, and the outlets 118 are designed to deliver the fluid with a predetermined amount of force, once the pressure within the manifold reaches a threshold level.

The disclosed rollers provide numerous advantages over other designs that employ cords, straps, rods, and/or planks opposite the surface conveying the containers. For example, the disclosed rollers can be a passive solution, can rotate to aid in conveyance, and can be arranged in a variety of lanes (e.g., each roller may not be aligned with every other roller). For instance, the containers may be guided by one or more rollers a first distance from an edge of the system 100, and one or more rollers a second distance from the edge of the system, depending on the application and/or container. Further, a compromised roller may be removed and replaced without the need to replace the entire line of rollers.

In disclosed examples, a system for drying a container includes an air manifold having a plurality of outlets to deliver pressurized air; a surface to support one or more containers; and a frame arranged a predetermined distance from the surface, the frame configured to brace the one or more containers against forces acting on the one or more containers from the pressurized air.

In some examples, the frame includes one or more rollers arranged at an angle relative to a direction of flow of the pressurized air. In examples, the angle is substantially perpendicular.

In some examples, one or more mounting devices are configured to maintain the distance of the frame relative to the surface. In examples, the one or more mounting devices includes an adjustable fastener configured to adjust the distance of the frame relative to the surface. In examples, the adjustable fastener is manually adjustable.

In some examples, one or more support braces are configured to bolster the frame relative to the surface.

In some examples, a conveyer system drives the surface as a movable belt to convey the one or more containers along the conveyer system. In examples, a position or orientation of the plurality of outlets is fixed relative to the movable belt and the one or more containers along the conveyer system.

In some disclosed examples, a frame to support containers during drying includes one or more rollers to brace the one or more containers against forces acting on the one or more containers from pressurized air from an air manifold having a plurality of outlets to deliver the pressurized air; and one or more mounting devices configured to maintain a predetermined distance between a surface supporting the one or more containers and the one or more rollers.

In some examples, the predetermined distance is selected to allow the one or more containers to traverse the frame while contacting one or more surfaces of the one or more containers during application of the pressurized air.

In examples, one or more rails to support two or more rollers of the one or more rollers are included. In examples, the one or more rails are mounted to the one or more mounting devices, the one or more rails to support the two or more rollers such that the two or more rollers contact a surface of the one or more containers during application of the pressurized air.

In some examples, the one or more mounting devices includes an adjustable fastener configured to adjust the distance of the frame relative to the surface.

In some examples, one or more support braces configured to bolster the frame relative to the surface are included.

In some examples, the one or more rollers are arranged in line with the direction of conveyance of the one or more containers.

In some examples, the one or more rollers are arranged to brace the one or more containers being formed of a flexible material that changes shape in response to the pressurized air.

In some examples, the one or more rollers are arranged to brace the one or more containers being formed of a rigid material.

In some examples, the one or more rollers are fitted with rubber rings arranged to contact the one or more containers.

In some examples, one or more springs to bias the frame or the one or more rollers toward the surface are included.

Although several examples and/or embodiments are described with respect to a frame system for drying containers, the principles and/or advantages disclosed herein can employ technologies that are not limited to a particular type of material and/or application.

When introducing elements of various embodiments described below, the articles “a,” “an,” and “the” are intended to mean that there are one or more of the elements. The terms “comprising,” “including,” and “having” are intended to be inclusive and mean that there may be additional elements other than the listed elements. Moreover, while the term “exemplary” may be used herein in connection to certain examples of aspects or embodiments of the presently disclosed subject matter, it will be appreciated that these examples are illustrative in nature and that the term “exemplary” is not used herein to denote any preference or requirement with respect to a disclosed aspect or embodiment. Additionally, it should be understood that references to “one embodiment,” “an embodiment,” “some embodiments,” and the like are not intended to be interpreted as excluding the existence of additional embodiments that also incorporate the disclosed features.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

While only certain features of the invention have been illustrated and described herein, many modifications and changes will occur to those skilled in the art. It is, therefore, to be understood that the appended claims are intended to cover all such modifications and changes as fall within the true spirit of this disclosure.

What is claimed is:

1. A system for drying a container comprising:
an air manifold having a plurality of outlets to deliver pressurized air;
a surface to support one or more containers; and
a frame arranged a predetermined distance from the surface, the frame configured to brace the one or more containers against forces acting on the one or more containers from the pressurized air.

2. The system of claim 1, wherein the frame comprises one or more rollers arranged at an angle relative to a direction of flow of the pressurized air.

3. The system of claim 2, wherein the angle is substantially perpendicular.

4. The system of claim 1, further comprising one or more mounting devices configured to maintain the distance of the frame relative to the surface.

5. The system of claim 4, wherein the one or more mounting devices includes an adjustable fastener configured to adjust the distance of the frame relative to the surface.

6. The system of claim 5, wherein the adjustable fastener is manually adjustable.

7. The system of claim 1, further comprising one or more support braces configured to bolster the frame relative to the surface.

8. The system of claim 1, further comprising a conveyer system, wherein the surface is a movable belt to convey the one or more containers along the conveyer system.

9. The system of claim 8, wherein a position or orientation of the plurality of outlets is fixed relative to the movable belt and the one or more containers along the conveyer system.

10. A frame to support one or more containers during drying comprising:
one or more rollers to brace the one or more containers against forces acting on the one or more containers from pressurized air from an air manifold having a plurality of outlets to deliver the pressurized air; and
one or more mounting devices configured to maintain a predetermined distance between a surface supporting the one or more containers and the one or more rollers.

11. The frame of claim 10, wherein the predetermined distance is selected to allow the one or more containers to traverse the frame while contacting one or more surfaces of the one or more containers during application of the pressurized air.

12. The frame of claim 10, further comprising one or more rails to support two or more rollers of the one or more rollers.

13. The frame of claim 12, wherein the one or more rails are mounted to the one or more mounting devices, the one or more rails to support the two or more rollers such that the two or more rollers contact a surface of the one or more containers during application of the pressurized air.

14. The frame of claim 10, wherein the one or more mounting devices includes an adjustable fastener configured to adjust the distance of the frame relative to the surface.

15. The frame of claim 10, further comprising one or more support braces configured to bolster the frame relative to the surface.

16. The frame of claim 10, wherein the one or more rollers are arranged in line with the direction of conveyance of the one or more containers.

17. The frame of claim 10, wherein the one or more rollers are arranged to brace the one or more containers being formed of a flexible material that changes shape in response to the pressurized air.

18. The frame of claim 10, wherein the one or more rollers are arranged to brace the one or more containers being formed of a rigid material.

19. The frame of claim 10, wherein the one or more rollers are fitted with rubber rings arranged to contact the one or more containers.

20. The frame of claim 10, further comprising one or more springs to bias the frame or the one or more rollers toward the surface.
